(19) United States
(12) Patent Application Publication
(10) Pub. No.: US 2024/0059922 A1
(43) Pub. Date: Feb. 22, 2024

(54) FORMATION OF A MICROPOROUS MPL LAYER ON THE SURFACE OF AN ACTIVE LAYER FOR AN ELECTROCHEMICAL CONVERTER

(71) Applicant: COMMISSARIAT A L'ENERGIE ATOMIQUE ET AUX ENERGIES ALTERNATIVES, Paris (FR)

(72) Inventors: Clémence MARTY, Grenoble Cedex 09 (FR); Jean-François BLACHOT, Grenoble Cedex 09 (FR); Frédéric FOUDA-ONANA, Grenoble Cedex 09 (FR); Marie HEITZMANN, Grenoble Cedex 09 (FR); Joël PAUCHET, Grenoble Cedex 09 (FR); Pierre TOUDRET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/336,471

(22) Filed: Jun. 16, 2023

(30) Foreign Application Priority Data
Jun. 17, 2022 (FR) 22 05951

(51) Int. Cl. C09D 11/52; C09D 11/033; C09D 11/037; C09D 11/106; H01M 8/1004

(52) U.S. Cl. CPC C09D 11/52; C09D 11/033; C09D 11/037; C09D 11/106; H01M 8/1004; H01M 2008/1095

(57) ABSTRACT

A method may form an electroconductive and hydrophobic microporous layer (MPL) at an active layer surface configured for an electrochemical converter, including: (a) providing a non-aqueous dispersion, called “ink”, including a carbon-based particulate material and an organic solvent; (b) forming an ink deposit at the active layer surface; and (c) evaporating the solvent(s) to form a microporous layer, simultaneously and/or subsequently to the forming (b). The ink may include poly(vinylidene fluoride-co-hexafluoropropene), dissolved in the organic solvent. Ink may prepare such a microporous layer, and a multilayer structure including an active layer supported by a solid electrolyte membrane and contacting, at its face on the opposite side the solid membrane, with a microporous layer obtained by the such a method. A membrane-electrode assembly may include such a multilayer structure. Such an MEA may be used in an individual cell of an electrochemical converter, in particular in a PEMFC.

### CROSS-REFERENCE TO RELATED APPLICATIONS

The present application claims the benefit of the filing date of French Appl. No. 2205951, filed on Jun. 17, 2022, the content of each of which is incorporated by reference.

### BACKGROUND OF THE INVENTION

Field of the Invention The present invention relates to the preparation of an electroconductive and hydrophobic microporous layer (MPL) useful in the field of the manufacture of electrochemical converters, in particular of fuel cells, notably of proton-exchange membrane fuel cells, and polymer membrane electrolyzers.

More particularly, the invention relates to a novel method for forming a microporous layer directly at the surface of an active layer in the context of the preparation of a membrane-electrode assembly intended for an electrochemical converter.

### DESCRIPTION OF THE RELATED ART

Proton-exchange membrane fuel cells (denoted PEMFC) are electrochemical energy conversion devices which are considered to be a promising source of energy for transport applications. Although this technology has been at the forefront of marketing efforts over the last two decades, especially by motor vehicle manufacturers, breakthroughs are still needed in order to satisfy all the cost and durability specifications.

The operating principle of a PEMFC fuel cell is based on the conversion of chemical energy into electrical energy by catalytic reaction of hydrogen and oxygen. A fuel cell comprises at least one individual cell, but more generally a stack in series of several individual cells, in order to meet the needs of the applications. Each individual cell comprises a membrane-electrode assembly (better known by the acronym “MEA”), which is commonly referred to as the fuel cell core which constitutes the base element of PEMFCs.

The set of phenomena that give rise to the energy conversion takes place in the fuel cell core. As in any electrochemical system, it is formed of two electrodes, an anode and a cathode, separated by an electrolyte. In the case of the PEMFC, the latter is a polymer membrane having a thickness of between 10 and 20 inn. The electrodes are formed of two main parts: an active layer (or CL for “catalyst layer”), site of the electrochemical reactions catalyzed by platinum (having a thickness of 5 to 15 μm), and a diffusion layer (GDL for “gas diffusion layer”), having a thickness of between 150 and 300 μm.

This diffusion layer has a significant impact both on the performance levels and on the durability of the PEA/WC, due to its role in all of the transport phenomena that take place within the core of the fuel cell. Thus, the diffusion layer is used for collecting current, for supplying reactive gas, but also for eliminating water and heat produced within the fuel cell core.

In order to meet all of these requirements, and enable in particular good elimination of water, it has been proposed to include a carbon-based microporous layer, referred to as “MPL”, between the catalyst layer and the gas diffusion layer.

Several alternatives for forming an MPL in a membrane-electrode assembly have been employed to date. The most common technique, represented in FIG. 1(b) (extract from publication [2]), consists in depositing the layer for forming the MPL on a GDL, then the MPL+GDL assembly undergoes a hydrophobic heat treatment at a very high temperature, before being assembled on a CCM (“catalyst coated membrane”, denoting the assembly of an electrolyte membrane that is coated on each of its opposite faces with a catalyst layer) structure, with or without hot pressing.

Another technique, used in research, consists in preparing a self-supporting MPL. The microporous layer is thus produced, separately, on an inert substrate from which it can be separated after heat treatment. The production of a self-supporting MPL, separate from the GDL, advantageously makes it possible to vary, during tests, only the nature of the GDL. However, this method is not suitable for an industrial approach since self-supporting MPL layers have very low mechanical strength, making them very difficult to handle.

In the context of either of these techniques, the presence of interfacial gaps between the active layer and the MPL is inevitable, notably as a result of the roughnesses of the surfaces of the active layer and of the MPL. However, these gaps are detrimental to the performance levels of the individual cell, notably due to the fact that water tends to accumulate therein, in particular for high operating current densities.

To overcome this disadvantage, Daniel et al. [1] propose a method for preparing the MPL directly on the active layer, by spraying a dispersion (more commonly called “ink”) formed from the mixture of a solution of PTFE AF 1600 (poly[4,5-difluoro-2,2-bis(trifluoromethyl)-1,3-dioxole-co-tetrafluoroethylene]) in a fluorinated solvent, of FC-72 or Fluorinere) FC-40 type, with a solution of carbon black, and dilution with isopropanol.

This technique however has several drawbacks, in particular with regard to its ability to be employed on an industrial scale. On the one hand, it requires, for the dissolution of the polymer, the use of a fluorinated solvent, which is not desirable due to its toxicity.

On the other hand, such a method does not make it possible to deposit the ink by a technique other than spraying. In fact, the ink is based on isopropanol, a solvent that reacts with the materials of the active layers. Depositing the ink by spraying enables rapid evaporation of the solvent and a reduced contact time of the surface of the active layer with the solvent. By contrast, depositing the ink by coating is not an option with this method due to the risk of deteriorating the active layer.

Finally, this method requires, subsequently to the deposition of the layer, a step of sintering, heat treatment requiring a high temperature, to be carried out in order to make the layer hydrophobic.

Thus, there remains a need to be able to have a simplified method for preparing a microporous layer (MPL) directly at the surface of the active layer in the context of the preparation of a membrane-electrode assembly intended for an electrochemical converter, for example a PEMFC, which makes it possible to overcome the aforementioned constraints.

In particular, there remains a need to have a method for preparing an MPL directly at the surface of the active layer, without the risk of damaging the latter, which makes it possible to deposit the ink by spraying or coating, while making it possible to obtain an MPL which has the required physicochemical properties, in particular good hydrophobicity properties and good mechanical strength.

### BRIEF SUMMARY OF THE INVENTION

The invention aims precisely to meet these expectations.

More particularly, the invention relates, according to a first of its aspects, to a method for forming an electroconductive and hydrophobic microporous layer (MPL) at the surface of an active layer intended for an electrochemical converter, said method comprising at least the following steps:
(a) providing a non-aqueous dispersion, called “ink”, comprising at least one carbon-based particulate material and at least one organic solvent;
(b) forming a deposit of said ink at the surface of said active layer; and
(c) evaporating said solvent or solvents in order to form said microporous layer MPL, step (c) being carried out simultaneously and/or subsequently to step (b);

wherein said ink comprises at least one poly(vinylidene fluoride-co-hexafluoropropene), denoted PVDF-HFP, copolymer in solution in said organic solvent.

To the knowledge of the inventors, forming a microporous layer using a PVDF-HFP copolymer has never been proposed before.

The invention also relates, according to another of its aspects, to a non-aqueous dispersion or ink, for the preparation of a microporous layer intended for an electrochemical converter, said ink comprising at least:
at least one carbon-based particulate material in dispersion in at least one organic solvent; and
at least one poly(vinylidene fluoride-co-hexafluoropropene), denoted PVDF-HFP, copolymer dissolved in said organic solvent.

Said invention also relates to the use of an ink as defined above for forming a microporous layer directly at the surface of an active layer in the context of the preparation of a membrane-electrode assembly intended for an electrochemical converter, for example a PEMFC.

“Non-aqueous dispersion” means a dispersion of solid particles in one or more organic solvents, and which does not contain water or, failing that, contains a very small quantity of water, in particular less than 1% by mass, notably less than 0.1% by mass.

Advantageously, the use of a PVDF-HFP copolymer according to the invention allows the use of a large panel of solvents that are capable of dissolving said polymer.

Advantageously, the method for preparing an MPL according to the invention makes it possible to dispense with the use of fluorinated solvent.

Advantageously, the ink for forming the MPL uses one or more organic solvents that are inert with respect to the active layer on the surface of which the MPL layer is formed.

In the context of the present invention, “inert” solvent means a solvent that is not reactive with respect to the material of the active layer, and as a result is not likely to damage or degrade said active layer with which it comes into contact.

The use according to the invention of an organic solvent that is inert with respect to the active layer advantageously allows the deposition of the ink for the preparation of the MPL layer, directly at the surface of the active layer, and by any deposition technique, in particular by spraying, but also by coating; without the risk of deteriorating the active layer.

Thus, unlike the method described by Daniel et al.[1] which, taking into account the solvent of the ink used, isopropanol, that is reactive with respect to the active layer, can only apply the ink by spraying so as to enable very rapid evaporation of the solvent and reduce the contact time with the active layer to a minimum, the ink according to the invention is suitable for application by any deposition technique, in particular by spraying or by coating.

Preferably, the ink for forming the MPL comprises a single organic solvent, enabling both the dispersion of the carbon-based particulate material or materials and the dissolution of the PVDF-HFP.

In a preferred embodiment, the ink comprises, as organic solvent, in particular as sole organic solvent, ethyl acetate.

Furthermore, advantageously, the preparation of a microporous layer according to the invention does not require a sintering step. As indicated above, in the methods that are usually proposed for forming the MPL layer, the sintering step is necessary in order to modify the crystalline structure of the polymer of the MPL layer so as to achieve the desired hydrophobicity for the MPL. In contrast, the preparation of an MPL layer based on a PVDF-HFP copolymer according to the invention makes it possible to obtain a layer having good hydrophobicity without needing to use a sintering step.

Thus, as detailed in the text that follows, the preparation of an ink, and the formation of an MPL according to the method of the invention, are particularly easy.

Within the meaning of the invention, a layer is said to be “hydrophobic” if the external surface of its constituent material is such that a deposited drop of water does not spread thereon. In particular, the liquid/gas interface of the drop of water forms a contact angle with the surface of greater than 90°. This hydrophobic character is of course also reproduced throughout the thickness of the layer, in particular in the porosity of the material. It may notably be monitored by XPS analysis of the surface of a cross section through this layer.

Advantageously, the microporous layer formed according to the invention combines good hydrophobicity properties with good mechanical properties. The method of the invention notably makes it possible to obtain microporous layers that are homogeneous, flexible and crack-resistant.

The invention also relates, according to another of its aspects, to a multilayer structure, useful for the preparation of a membrane-electrode assembly intended for an electrochemical converter, for example a PEMFC fuel cell, comprising at least one active layer supported by a solid electrolyte membrane; and more particularly belonging to a catalyst coated membrane referred to as CCM;

said active layer being in contact, at its face on the opposite side to said solid membrane, with an electroconductive and hydrophobic microporous layer (MPL) obtained by a method of the invention, as defined above, in particular obtained by depositing an ink according to the invention on the surface of said active layer.

As indicated above, the microporous layer is formed according to the invention in the context of the manufacture of a membrane-electrode assembly, referred to as MEA, intended for an electrochemical converter, for example a PEMFC.

Thus, according to another of its aspects, the invention relates to the use of a multilayer structure as defined above for the preparation of a membrane-electrode assembly intended for an electrochemical converter, for example a PEMFC.

The invention also relates to a membrane-electrode assembly, referred to as MEA, intended for an electrochemical converter, for example a PEMFC, comprising a multilayer structure according to the invention, said assembly comprising more particularly the following stack: GDL/MPL/CCM/MPL/GDL,
GDL denoting diffusion layers, typically of carbon-based substrate type, for example made of carbon paper, impregnated with PTFE;
MPL denoting microporous layers;
CCM (“catalyst coated membrane”) denoting an electrolyte membrane that is coated on either side with a cathode catalyst layer (CCL) and with an anode catalyst layer (ACL);
at least one of the MPL layers being formed by a method according to the invention, as defined above, using an ink as defined above.

Advantageously, forming the MPL directly at the surface of an active layer, in particular on the CCM structure, makes it possible to vary the nature of the GDL, so as to optimize the membrane-electrode assembly.

The invention also relates, according to another of its aspects, to the use of a multilayer structure according to the invention as defined above or of a membrane-electrode assembly according to the invention as defined above, in an individual cell of an electrochemical converter, in particular in an individual cell of a fuel cell and more particularly in an individual cell of a proton-exchange membrane fuel cell (PEMFC).

Other features, variants and advantages of the formation of an MPL according to the invention, of the use thereof in a membrane-electrode assembly for an electrochemical converter, will emerge more clearly on reading the description, the examples and the figures that follow, which are given as nonlimiting illustrations of the invention.

In the text that follows, the expressions “between . . . and . . . ”, “ranging from . . . to . . . ” and “varying from . . . to . . . ” are equivalent and are intended to mean that the limits are included, unless mentioned otherwise.

### BRIEF DESCRIPTION OF THE DRAWINGS

FIG. 1A is a diagram of the prior art {extract from publication [2]) showing a membrane-electrode assembly (MEA) architecture of an MEA without an MPL layer.

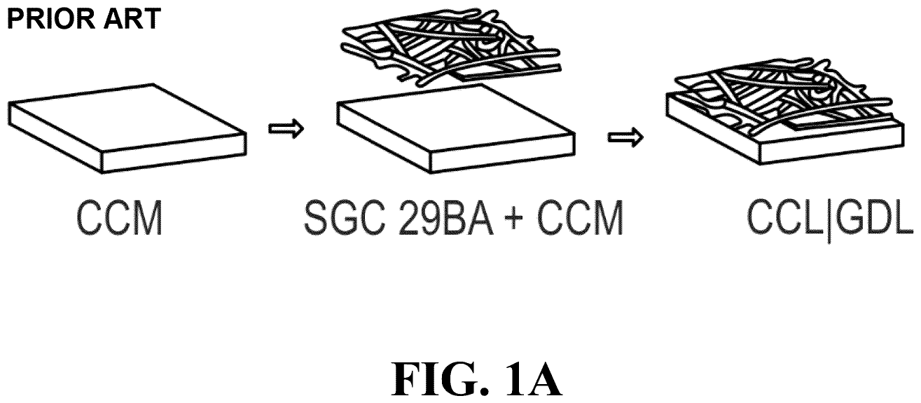

FIG. 1B is a diagram of the prior art (extract from publication [2]) showing a membrane-electrode assembly (MEA) architecture of an MEA with a commercial MPL layer.

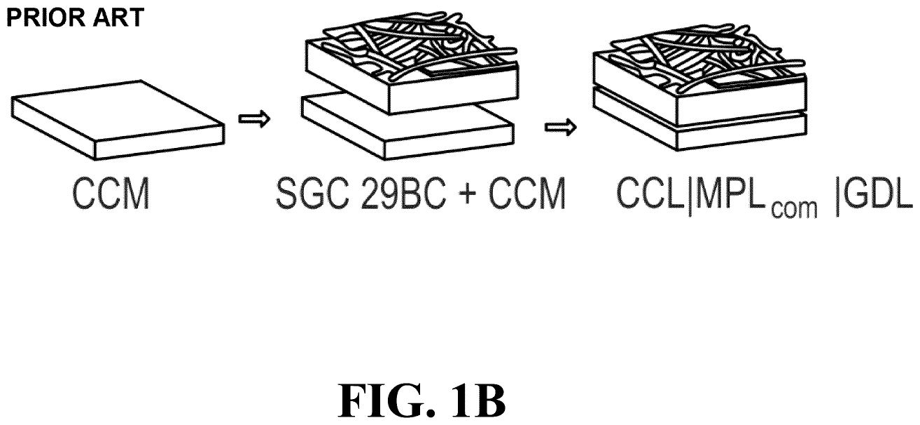

FIG. 1C is a diagram of the prior art (extract from publication [2]) showing a membrane-electrode assembly (MEA) architecture of an MEA with a modified MPL layer on the CCM.

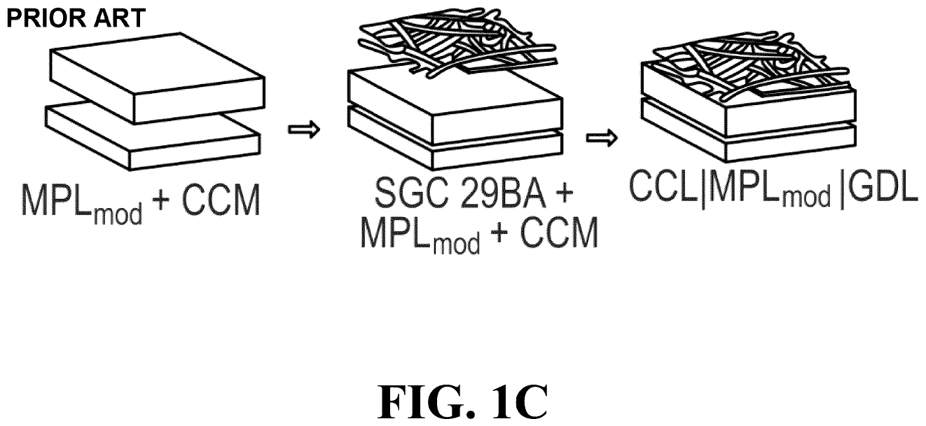

FIG. 1D is a diagram of the prior art (extract from publication [2]) showing a membrane-electrode assembly (MEA) architecture of an MEA with a double MPL layer.

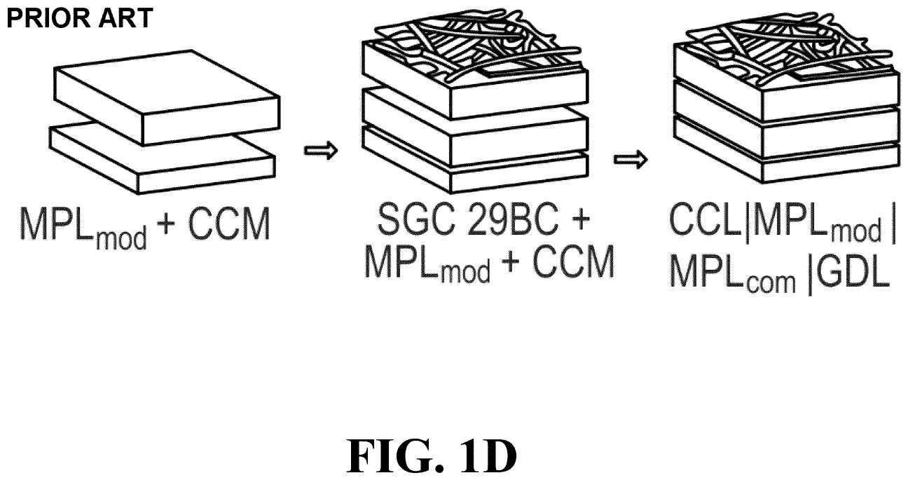

FIG. 2A shows a photograph of the device used for the ink coating for the preparation of the MPL layer according to Example 1.

FIG. 2B shows a schematic representation of the device used for the ink coating for the preparation of the MPL layer according to Example 1;

FIG. 3A shows a photograph obtained by scanning electron microscopy (SEM) of the complete MEA assembly formed in Example 1 (GDL/MPL/CCM/MPL/GDL, the upper MPL layer being a layer formed according to the invention), at 10 μm magnification.

FIG. 3B shows a photograph obtained by scanning electron microscopy (SEM) of the complete MEA assembly formed in Example 1 (GDL/MPL/CCM/MPL/GDL, the upper MPL layer being a layer formed according to the invention), at 100 μm magnification.

FIG. 4A schematically shows the production of the reference MEAs, formed in a conventional manner by assembling MPL/GDL structures to each of the active layers of a CCM structure.

FIG. 4B schematically the production of the MEAs according to the invention, formed by assembling, on the cathode side, a GDL to the CCM/MPL structure formed according to the invention integrating an MPL formed according to the invention directly at the surface of the cathode active layer of the CCM.

FIG. 5 represents the polarization curves (voltage (V) as a function of the current density (A/cm²)) of the individual cells obtained with each of the MEAs in Example 2.

### DETAILED DESCRIPTION OF THE INVENTION

### Ink for the Preparation of the MPL

As indicated above, the invention is based on the formation of the microporous layer, referred to as “MPL” in the text that follows, directly at the surface of the active layer, from a non-aqueous dispersion, called “ink”, comprising at least one carbon-based particulate material and at least one poly(vinylidene fluoride-co-hexafluoropropene), denoted PVDF-HFP in the text that follows, copolymer dissolved in at least one organic solvent.

### PVDF-HFP Copolymer

A PVDF-HFP copolymer used according to the invention more particularly has the following structure (I):

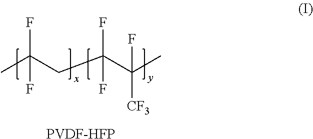

x corresponding to the average number of monomer units derived from vinylidene fluoride and y the average number of monomer units derived from hexafluoropropene.

The sequence of the monomer units derived from vinylidene fluoride and from hexafluoropropene in the PVDF-HFP may be random, of monoblock or multiblock type, preferably monoblock or multiblock. The HFP units are preferably grafted to the chain ends of the PVDF polymer.

According to a particular embodiment, a PVDF-HFP suitable for the invention advantageously has a number-average molecular mass Mₙ of between 300 g.mol⁻¹ and 600 g.mol⁻¹. The number-average molar mass may be measured by size-exclusion chromatography (or SEC). It may also be obtained from ¹H NMR analysis of the (co)polymer obtained.

The PVDF-HFP copolymers may be synthesized by methods known to those skilled in the art, or else may be commercially available.

By way of example, a PVDF-HFP copolymer suitable for the invention may be sold under the reference PVDF-HFP Solef® 21216 by Solvay.

Said PVDF-HFP copolymer(s) may be used for the ink used for the formation of the MPL layer in a proportion of 0.3% by 5% by mass, in particular of 0.4% to 2% by mass, relative to the total mass of the ink.

### Organic Solvent

With regard to the organic solvent, it is selected so as to dissolve the PVDF-HFP copolymer and to disperse said carbon-based particulate material or materials.

In particular, the PVDF-HFP copolymer may be dissolved in said organic solvent in a proportion of at least 2% by mass, in particular at a content of 2% to 5% by mass.

Advantageously, as mentioned above, the use of a PVDF-HFP copolymer according to the invention, in particular in comparison with PTFE as used in the method described by Daniel et al. [1], allows the use of a large panel of solvents that are capable of dissolving the polymer.

In addition, advantageously, said organic solvent or solvents used according to the invention are different from fluorinated solvents, the latter being undesirable for reasons of toxicity.

The organic solvent of the ink may notably be selected from acetone, acetonitrile, ethyl acetate, butanone (MEK), tetrahydrofuran (THF), dimethylacetamide (DMAC), N,N dimethylformamide (DMT), and mixtures thereof; preferably from acetone, acetonitrile, ethyl acetate, butanone, tetrahydrofuran (THF) and mixtures thereof.

Advantageously, the method of the invention uses an organic solvent that is inert with respect to the active layer on the surface of which the MPL is intended to be formed.

As mentioned above, the use according to the invention of an organic solvent that is inert with respect to the active layer advantageously allows the deposition of the ink for the preparation of the MPL layer, directly at the surface of the active layer, and by any deposition technique.

Thus, unlike the method described by Daniel et al. [1] which, taking into account the solvent of the ink used, isopropanol, that is reactive with respect to the active layer, can only apply the ink by spraying so as to enable very rapid evaporation of the solvent and reduce the contact time with the active layer to a minimum, the ink according to the invention is suitable for application by any deposition technique, in particular by spraying but also by coating.

According to a particular embodiment of the invention, the organic solvent used, in addition to dissolving the polymer, is inert with respect to the active layer on the surface of which the ink is intended to be deposited.

Preferably, the ink uses, as organic solvent, in particular as sole organic solvent, ethyl acetate.

Said organic solvent or solvents, in particular ethyl acetate, may represent from 70% to 90% by mass, in particular from 80% to 85% by mass, of the total mass of the ink.

### Carbon-Based Particulate Material

The ink comprises at least one carbon-based particulate material in dispersion in said organic solvent or solvents.

The carbon-based particulate material is dedicated to giving the MPL layer its electroconductive properties. It also makes it possible to increase the thermal conductivity allowing the heat produced in the individual cell of a fuel cell to be removed.

Generally, the carbon-based particulate material has an average particle size of less than one millimeter, in particular less than 5 μm and more particularly less than 100 nm, notably of between 20 nm and 50 nm.

The average particle size may be evaluated by scanning electron microscopy.

It is understood that the nature of the carbon-based material or materials used for the ink, in particular the average particle size of the carbon-based material or materials used, is adjusted with regard to the means chosen to deposit the ink at the surface of the active layer.

In particular, when the deposition of the ink is carried out by spraying, said carbon-based particulate material or materials must have a particle size that is suitable for the spraying device, in particular suitable for the diameter of the nozzle of the spraying device, so as to avoid clogging the nozzle.

In particular, in the case of an ink intended to be deposited by spraying, said carbon-based particulate material or materials advantageously has/have an average particle size of less than or equal to 5 μm and more particularly of between 20 and 100 nm.

Said carbon-based particulate material or materials may be selected from carbon black, activated carbon, graphite, carbon nanotubes, carbon nanofibers, milled carbon fibers, and mixtures thereof, preferably from carbon black, carbon nanofibers, notably vapor-grown carbon nanofibers, and mixtures thereof.

In particular, the ink may comprise a single type of particulate carbon-based material, or a mixture of at least two particulate carbon-based materials.

The particulate carbon-based material may comprise at least carbon black, for example sold under the trade mark Vulcan XC72R® with dry extract of 99% sold by Tanaka.

The particulate carbon-based material may comprise carbon nanofibers.

Advantageously, these carbon fibers are vapor grown. In particular, these fibers may comprise graphitized carbon. They are generally characterized by a length of 1 to 50 μm and preferably 5 to 25 μm. The vapor-grown carbon fibers advantageously make it possible to increase the thermal and electrical conductivities while limiting the number of cracks that form while the MPL layer is drying.

For example, they may be carbon nanofibers, sold under the name VGCF® with dry extract of 99% by Showa Denko.

According to a particular embodiment, the ink comprises a mixture of carbon black and carbon nanofibers, notably vapor-grown carbon nanofibers.

The carbon-based particulate material or materials may be used in a proportion of 2% to 7% by mass, in particular 2% to 5% by mass, relative to the total mass of the ink.

### Preparation of the Ink for the MPL Layer

The contents of the various components of the ink, in particular of said PVDF-HFP copolymer or copolymers and of said carbon-based particulate material or materials, in said organic solvent or solvents, are adjusted so as to obtain an MPL layer which combines a porosity suitable for the diffusion of the gases and optimal transport of the products, low electrical resistivity, satisfactory mechanical stability and satisfactory thermal conductivity.

In particular, the ink for the preparation of the MPL layer may comprise from 2% to 7%, in particular from 2% to 5%, by mass of carbon-based particulate material(s), from 0.3% to 5%, in particular from 0.4% to 2%, by mass of PVDF-HFP and from 70% to 90%, in particular from 80% to 85%, by mass of organic solvent(s), in particular as defined above, the solvent preferably being ethyl acetate.

The content of PVDF-HFP copolymer in the ink may vary between 5% and 10% by mass relative to the total mass of the ink, expressed as dry extract.

In a particular embodiment, said carbon-based particulate material or materials and PVDF-HFP copolymer may be used in a carbon-based material(s)/PVDF-HFP mass ratio ranging from 2 to 6.

The ink according to the invention may be obtained by mixing, in said organic solvent or solvents, in particular in ethyl acetate, the PVDF-HFP and said carbon-based particulate material or materials.

Preferably, the PVDF-HFP is dissolved beforehand in the organic solvent, in particular in ethyl acetate, before being combined with the other components.

Preferably, the ink is obtained by mixing, in particular in this order, said particulate carbon-based material or materials, the PVDF-HFP, preferably dissolved beforehand in an organic solvent, notably in ethyl acetate, and the organic solvent.

Preferably, the mixture is dispersed.

Thus, the preparation of the ink is easy and advantageously requires few steps; it may thus be obtained beforehand by (i) dissolving the PVDF-HFP in the organic solvent, preferably in ethyl acetate, (ii) mixing with said carbon-based particulate material or materials in the organic solvent, then (iii) dispersing the mixture.

The components may for example be dispersed with a mechanical disperser, for example of rotor-stator type. Preferably, the dispersion is prepared with the aid of a vacuum disperser. In particular, before the dispersion step, the various carbon-based particulate materials are first mixed, then the PVDF-HFP is added, and finally the organic solvent, notably ethyl acetate.

The dispersion obtained may preferably then be subjected to stirring, for example with the aid of a stirrer of roller-tube type. As stirrer, mention may be made of stirrers of roller-tube type. Zirconium beads, for example having a diameter of between 2 mm and 3 mm, for example a diameter of 3 mm, may be added to the dispersion.

The ink prepared according to the invention advantageously has a good dispersion of the carbon-based particulate materials in the organic solvent, in particular ethyl acetate, in which the PVDF-HFP copolymer is dissolved.

### Formation of the MPL Layer

As mentioned above, the preparation of the MPL layer according to the invention involves the formation of a deposit of said ink, in particular as defined above, directly at the surface of the active layer, and the evaporation of the organic solvent or solvents, in order to form the MPL layer.

The active layer on the surface of which the MPL layer according to the invention is formed may be a cathode catalyst layer, referred to as “CCL”, or an anode catalyst layer, referred to as “ACL”.

The active layer is more particularly supported by a solid membrane, in particular a solid electrolyte membrane, the deposition of the ink in step (b) being carried out on the face of said active layer on the opposite side to the solid membrane.

The active layer on the surface of which the ink according to the invention is deposited may thus more particularly belong to a catalyst coated membrane, referred to as CCM, denoting the assembly of a membrane that is coated on each of its opposite faces with a catalyst layer (active layer).

The CCM membrane used may be selected from those commonly used for the preparation of electrochemical converters, notably of fuel cells and polymer membrane electrolyzers.

As mentioned above, the deposition of the ink may be carried out advantageously by coating or by spraying.

Advantageously, the deposition is carried out so as to control the thickness of the deposit at the surface of the active layer.

The coating may for example be carried out by roller, doctor blade or knife.

Advantageously, the deposition of the ink is carried out at a temperature of between 60° C. and 80° C., in particular between 70° C. and 80° C.

The evaporation of the organic solvent, in particular of the ethyl acetate, may be carried out simultaneously to the deposition of the ink, notably during a deposition by spraying, and/or after deposition of the ink, notably during a deposition by coating. The drying after deposition may be carried out for example for a few minutes, for example from 1 to 15 minutes, notably from 1 to 10 minutes, for example around 5 minutes.

Preferably, when the deposition of the ink is carried out by coating, the structure comprising the active layer superposed on a membrane, in particular the CCM membrane, is fixed, for example with the aid of an adhesive tape, advantageously on a rigid support, for example on a polytetrafluoroethylene (PTFE) substrate, this being to avoid a shrinkage phenomenon of the membrane in the presence of a large quantity of solvent.

The evaporation of said organic solvent or solvents, in particular of ethyl acetate, may be carried out by heating to a temperature of less than or equal to 80° C., in particular of between 60° C. and 80° C., in particular between 70° C. and 80° C.

Advantageously, as mentioned above, the formation of the MPL layer according to the invention does not require any sintering step. “Sintering” is intended to mean a heat treatment to a temperature beyond the melting temperature of the polymer present in the MPL layer. This sintering step is generally necessary, for example in the case of the use of PTFE, in order to modify the crystalline structure of the polymer and achieve the desired hydrophobicity of the MPL layer.

In the context of the present invention, the PVDF-HFP makes it possible to provide the MPL layer formed according to the invention with the necessary hydrophobicity without using a sintering step.

The MPL layer formed according to the invention at the surface of an active layer advantageously has a thickness of between 30 μm and 70 μm, in particular between 40 μm and 60 μm, even more particularly between 45 μm and 55 μm.

As disclosed in the examples that follow, the method of the invention advantageously makes it possible to obtain MPL layers having a smaller thickness than commercial MPL layers. A decrease in the thickness is likely to allow a decrease in the oxygen transport resistance, and thus increase the performance levels of the electrochemical converter.

### Electrochemical Converter

As mentioned above, the method of the invention makes it possible to prepare MPL layers in the context of the manufacture of a membrane-electrode assembly, referred to as MEA, for an electrochemical converter, in particular for proton-exchange membrane fuel cells (PEMFCs) or polymer membrane electrolyzers.

The invention thus targets, according to another of its aspects, the use of a multilayer structure according to the invention comprising an MPL layer formed according to the invention, for the preparation of a membrane-electrode assembly intended for an electrochemical converter, for example a PEMFC.

A membrane-electrode assembly (MEA) according to the invention comprising an MPL layer according to the invention comprises more particularly the following stack:
GDL/MPL/CCMIMPL/GDL,
GDL denoting gas diffusion layers, for example of carbon-based substrate type (for example, carbon nonwoven fabric, carbon woven fabric, carbon felt, carbon paper, etc.) impregnated with PTFE;
MPL denoting microporous layers;
CCM denoting a membrane that is coated on either side with a cathode catalyst layer (CCL) and with an anode catalyst layer (ACL);
at least one of the MPL layers being a layer formed according to the invention, in particular both MPL layers being layers formed according to the invention.

The preparation of a membrane-electrode assembly (MEA) according to the invention includes in particular the use, at the face of the MPL layer formed according to the invention, on the opposite side to the face in contact with the active layer, of a GDL layer.

The GDL layer may simply be joined to the MPL layer, without requiring hot pressing.

The invention will now be described by means of the examples that follow, which are given of course as nonlimiting illustrations of the invention.

### Example 1

### Formation of the Microporous Layer MPL According to the Invention Directly on an Active Layer and Integration in a Complete Membrane-Electrode Assembly (MEA)

### Preparation of the Ink for the Manufacture of the MPL

The Following Starting Materials were Used:
VGCF® carbon fibers with dry extract of 99% sold by Showa Denko;
Vulcan XC72® carbon black with dry extract of 99% sold by Tanaka;
polymer: poly(vinylidene fluoride/hexafluoropropene) or PVDF-HFP (sold under the reference PVDF-HFP Solef® 21216 by Solvay), dissolved at 2% by weight in ethyl acetate;
solvent: ethyl acetate.

The ink for forming the MPL was prepared from these starting materials, by mixing in the following order and in the quantities indicated in Table 1 below.

| Order of Introduction | Component | Mass (g) |
|---|---|---|
| 1 | Vulcan carbon | 0.438 |
| 2 | VGCF (carbon nanofibers) | 0.6 |
| 3 | 2 wt. % of PVDF-HFP in | 11.1 |
| | ethyl acetate | |
| 4 | ethyl acetate | 14.4 |

The solution was then dispersed in a DISPERMAT® pot for 30 minutes at 1000 revolutions per minute. Then, the pot was subsequently placed onto a stirrer of roller-tube type after zirconium beads having a diameter of 3 mm were added into the mixture in a volume equivalent to ⅓ the volume of ink. The zirconium beads are added directly into the mixture. Thus, by placing the pot on the roller tubes, the latter make it possible to add shearing as in the case of a conventional ball mill, but in a much gentler manner.

Formation of the MPL by Coating with the Ink

The coating was carried out on the same day on a coating table equipped with a porous support with suction and heating.

The ink is applied by coating onto the cathode side of a CCM (“catalyst coated membrane”) comprising catalyst layers on either side of a membrane (solid electrolyte), sold under the reference Gore® A510.1/M735.18/C580.4, that is to say onto the cathode active layer.

In order to avoid shrinkage of the membranes when they come into contact with a large quantity of solvent, the CCM is fixed on a 250 μm rigid support made of PTFE during the coating of the ink on the catalyst layer.

The coating was then carried out with the following parameters:
Knife height: 250 μm
Speed: 1 cm/s
Temperature of the table: 70° C.

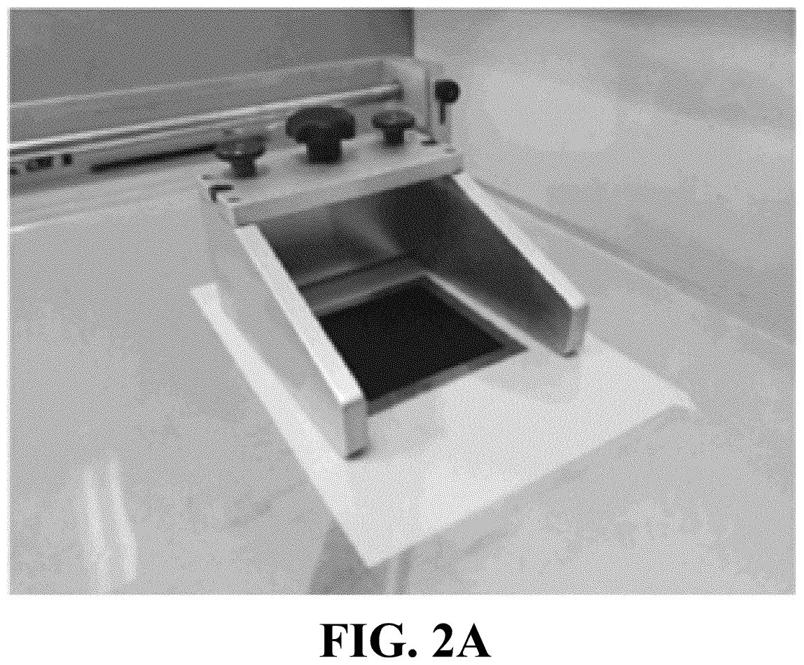

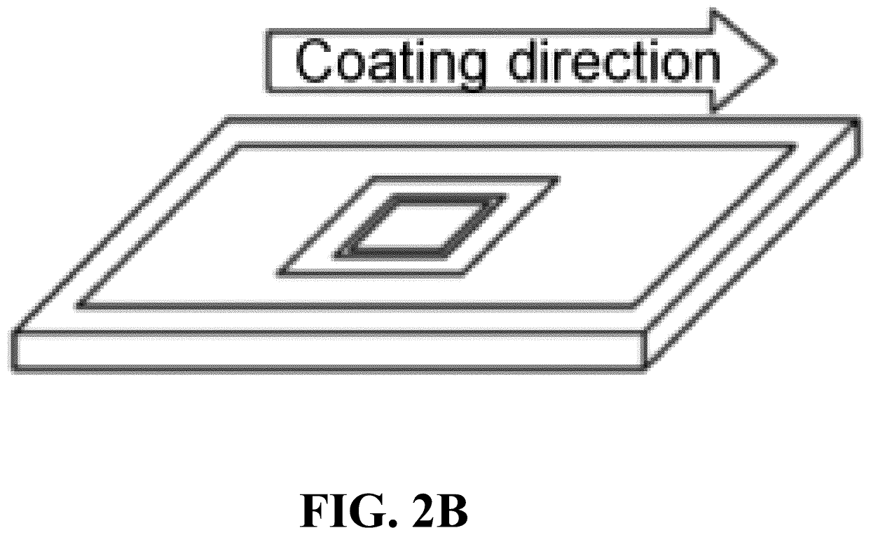

A thin film of polyethylene naphthalate (PEN) having a thickness of 50 μm is added on top of the CCM, before coating, in order to delimit the deposition zone, as represented schematically in FIG. 2.

The deposit is dried after coating at 70° C. for around 5 minutes. The temperature corresponds more particularly to the setpoint temperature of the heating plate on which the CCM membrane is deposited, the CCM membrane thus being at a slightly lower temperature.

Integration of the CCM/MPL according to the invention at a complete MEA A complete membrane-electrode assembly (MEA) is then formed by applying a GDL

formed of a carbon-based fibrous substrate impregnated with 5% by mass of PTFE, sold under the reference Sigracet® GDL 25 BA, to the MPL formed on the cathode active layer; and, on the anode side, by applying a GDL/MPL assembly, commercially available under the reference Sigracet® GDL 25 BC, formed of a carbon-based fibrous substrate impregnated with 5% by mass of PTFE and covered with a standard MPL (PTFE and carbon black).

In both cases the GDL, with or without MPL, is joined to the CCM during the assembly of the MEA in the individual cell without hot pressing.

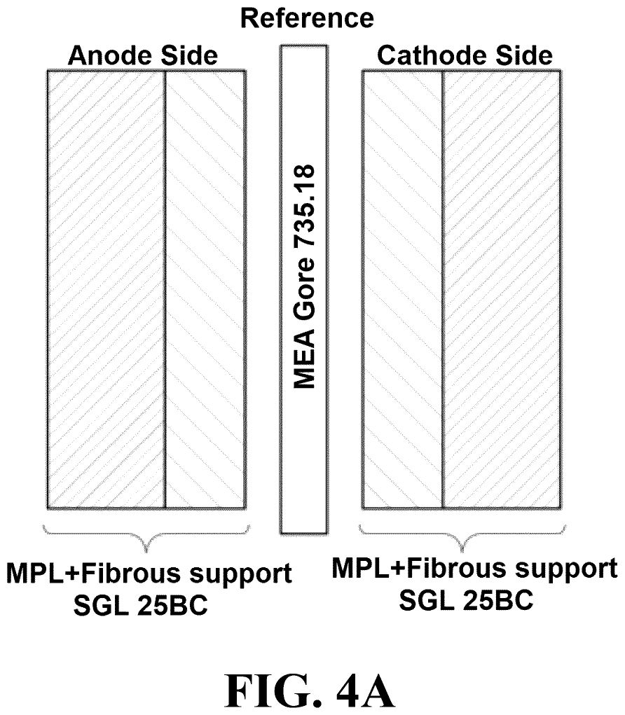

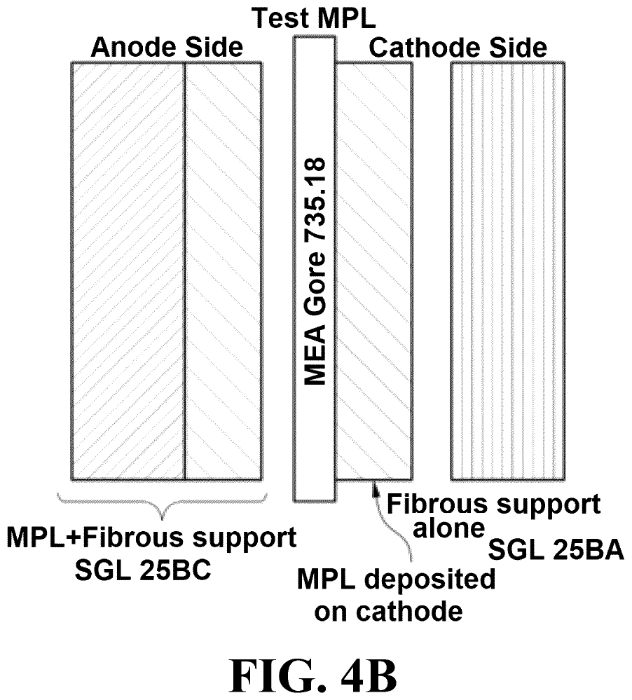

FIG. 4(b) schematically represents the production of the MEA according to the invention which integrates the CCM/MPL assembly produced according to the invention.

### Results

The macroporous layer obtained at the surface of the cathode active layer exhibits good adhesion on the active layer. The layer is flexible and does not crack when the CCM is handled.

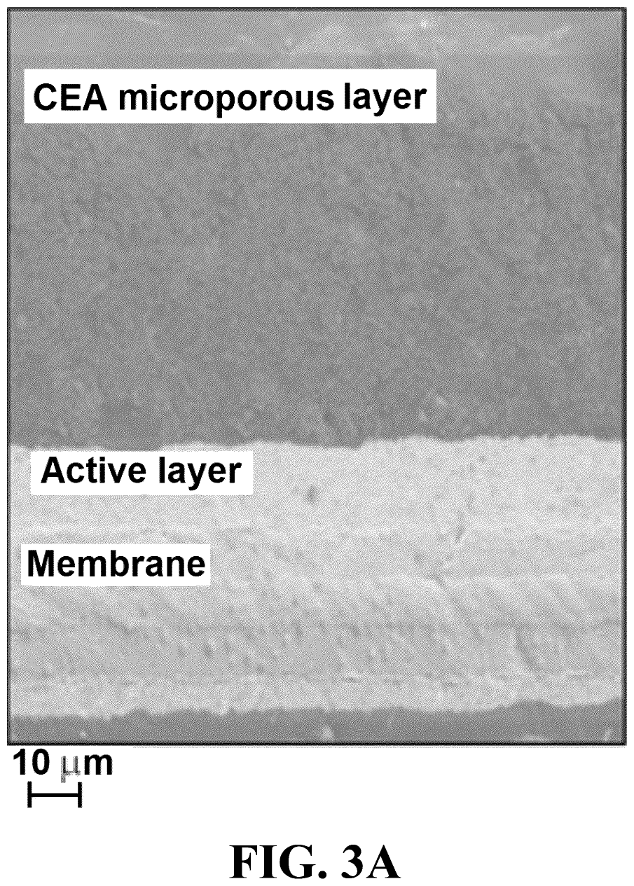

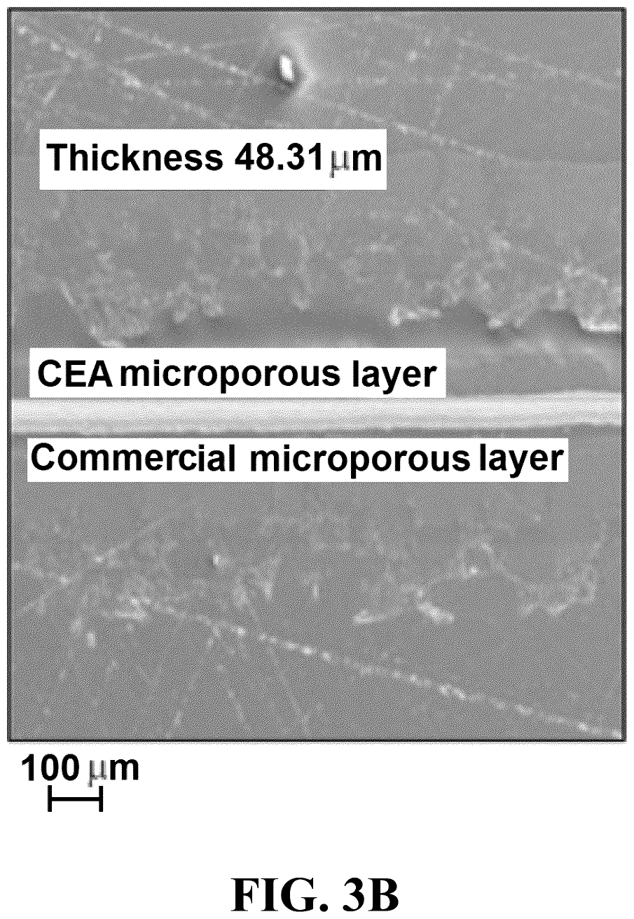

Observation, in cross section, by scanning electron microscopy (SEM) of the complete MEA assembly thus formed (FIG. 3) shows that the microporous layer MPL formed according to the invention has a thickness of the order of 50 μm. The deposit has a homogeneous thickness, and the active layer is intact and has

therefore not suffered any deterioration during the direct formation of the MPL according to the invention.

The method of the invention thus makes it possible to obtain MPL layers that are thinner than commercial layers, generally with a thickness of the order of 80 μm.

Obtaining a thinner layer is not detrimental. On the contrary, this decrease in thickness is likely to advantageously reduce the oxygen transport resistance.

### Example 2

### Evaluation in a Differential Cell

By way of comparison, a standard MEA is also investigated, formed of the assembly of diffusion layers sold under the reference Sigracet® GDL 25 BC, each formed of a carbon-based fibrous substrate impregnated with 5% by mass of PTFE and covered with a standard MPL, on either side of the CCM sold under the reference Gore® 735.18.

The two MEAs tested are represented in FIG. 4.

Each MEA is reproduced twice ((B1) and (B2) denoting the reference MEAs; and (B3), (B4) denoting the MEAs according to the invention).

The MEAs produced are tested in a differential cell of PEMFC type having a surface area of 1.8 cm².

The MEA is first conditioned for 6 hours by applying a voltage of 0.7 V. The fuel cell is heated to 80° C. under H₂ on the anode side and air on the cathode side at a relative pressure of 1.5 bar on each side. The gases are at a relative humidity of 80% and a stoichiometry of 20 at the anode and 30 at the cathode. The polarization curves are produced at the end of the conditioning under the same conditions as said conditioning, i.e. 80° C.; 1.5 bar; 80% RH, H²/air—stoichiometry 20-30. They are voltage-controlled and the sweep is effected starting from the OCV up to 0.1 V then back to the OCV at a sweep rate of 10 mV/s.

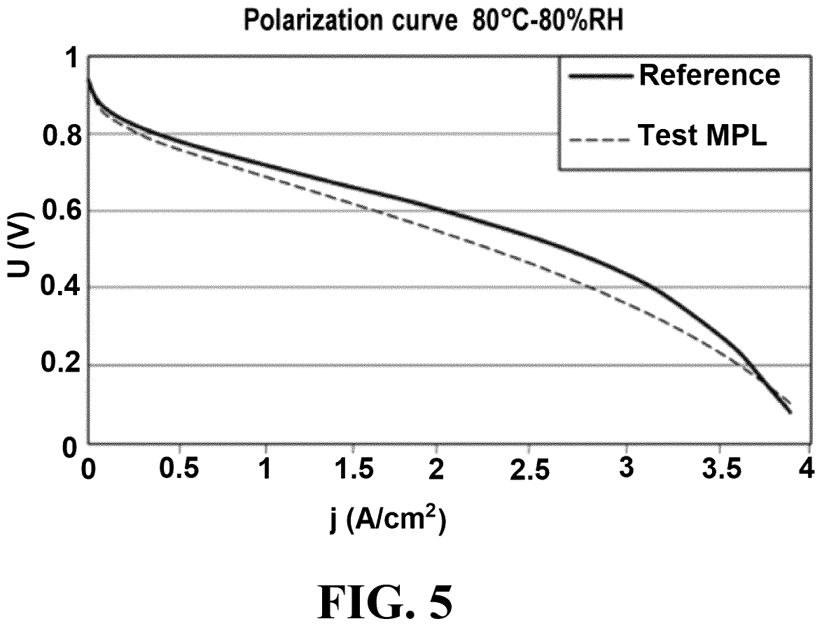

FIG. 5 represents the polarization curves (voltage (V) as a function of the current density (A/cm²)) of the individual cells obtained with each of the MEAs (B1), (B2), (B3) and (B4).

The performance levels of the microporous layer (MPL) prepared according to the invention are very close to the reference, confirming the effectiveness of the preparation method according to the present invention.

### REFERENCE

[1] Daniel et al, 2021, J. Electrochem. Soc. 168 104513;
[2] Daniel et al., New CCL MPL Architecture Reducing Interfacial Gaps and Enhancing PEM Fuel Cell Performance, in Fuel Cells, volume 20, 2020, No. 2, 224-228.

1. A method for forming an electroconductive and hydrophobic microporous layer at an active layer surface configured for an electrochemical converter, the method comprising:
forming a deposit of an ink, which is a non-aqueous dispersion comprising a carbon-based particulate material and an organic solvent, at the active layer surface; and
simultaneously and/or subsequently to the forming, evaporating the solvent to form the microporous layer;
wherein the ink comprises a poly(vinylidene fluoride-co-hexafluoropropene), (PVDF-HFP), copolymer in solution in the organic solvent, and
wherein the organic solvent comprises a sole organic solvent, which is ethyl acetate.

2. The method of claim 1, wherein the PVDF-HFP copolymer has a number-average molecular mass Mₙ in a range of from 300 to 600 g/mol.

3. A method for forming an electroconductive and hydrophobic microporous layer at an active layer surface configured for an electrochemical converter, the method comprising:
forming a deposit of an ink, which is a non-aqueous dispersion comprising a carbon-based particulate material and an organic solvent, at the active layer surface; and
simultaneously and/or subsequently to the forming, evaporating the solvent to form the microporous laver;
wherein the ink comprises a poly(vinylidene fluoride-co-hexafluoropropene), (PVDF-HFP), copolymer in solution in the organic solvent, and
wherein the organic solvent comprises acetone, acetonitrile, ethyl acetate, butanone (MEK), tetrahydrofuran (THF), dimethylacetamide (DMAC), N,N-dimethylformamide (DMF) and mixtures thereof, preferably from acetone, acetonitrile, ethyl acetate, butanone, tetrahydrofuran (THF), or a mixture thereof.

4. The method of claim 1, wherein the carbon-based particulate material has an average particle size of less than one millimeter.

5. The method of claim 1, wherein the carbon-based particulate material comprises carbon black, activated carbon, graphite, carbon nanotubes, carbon nanofibers, milled carbon fibers, or a mixture thereof.

6. The method of claim 1, wherein the ink comprises
the carbon-based particulate material in a range of from 2 to 7 wt. %,
the PVDF-HFP copolymer in a range of from 0.3 to 5 wt. %, and
the organic solvent in a range of from 70 to 90 wt. %.

7. The method of claim 1, further comprising preparing the ink beforehand comprising:
(i) dissolving the PVDF-HFP copolymer in the organic solvent;
(ii) mixing with the carbon-based particulate material in the organic solvent, to obtain a mixture; then
(iii) dispersing the mixture.

8. The method of claim 1, wherein an active layer of the active layer surface is supported by a solid electrolyte membrane,
wherein the ink in the forming is deposited on a face of the active layer on an opposite side to the solid electrolyte membrane.

9. The method of claim 1, wherein deposition in of the ink in the forming comprises coating or spraying.

10. The method of claim 1, wherein said MPL layer has a thickness of between 30 μm and 70 μm, in particular between 40 μm and 60 μm, even more particularly between 45 μm and 55 μm.

11. An ink suitable for preparing a microporous layer configured for an electrochemical converter, the ink comprising at least:
a carbon-based particulate material in dispersion in a single organic solvent; and
a poly(vinylidene fluoride-co-hexafluoropropene), (PVDF-HFP), copolymer dissolved in the organic solvent,
wherein the organic solvent is a sole organic solvent, which is ethyl acetate.

12. The ink of claim 11, wherein the PVDF-HFP copolymer has a number-average molecular mass Mₙ in a range of from 300 to 600 g/mol.

13. The method of claim 1, wherein the carbon-based particulate material has an average particle size of less than 5 μm.

14. The method of claim 1, wherein the carbon-based particulate material has an average particle size of less than 100 nm.

15. The method of claim 1, wherein the carbon-based particulate material has an average particle size in a range of from 20 to 50 nm.

16. The method of claim 1, wherein the carbon-based particulate material comprises carbon black, carbon nanofibers, or a mixture thereof.

17. The method of claim 1, wherein the carbon-based particulate material comprises vapor-grown carbon nanofibers.

18. The method of claim 8, wherein the active layer is a catalyst coated membrane.

19. The method of claim 9, wherein deposition is carried out at a temperature of in a range of from 60 to 80° C.
